(19) United States
(12) Patent Application Publication
(10) Pub. No.: US 2023/0312870 A1
(43) Pub. Date: Oct. 5, 2023

(54) Thermoset polymers for high temperature applications

(71) Applicant: National Technology & Engineering Solutions of Sandia, LLC, Albuquerque, NM (US)

(72) Inventors: Mathias C. Celina, Albuquerque, NM (US); Nicholas Henry Giron, Tijeras, NM (US); Estevan Jose Martinez, Albuquerque, NM (US); C. Garrett Campbell, Albuquerque, NM (US); John Kenneth Grey, Albuquerque, NM (US)

(21) Appl. No.: 17/707,727

(22) Filed: Mar. 29, 2022

(51) Int. Cl. C08K 5/05; C08K 5/07; B01J 31/16; C08G 73/12

(52) U.S. Cl. CPC C08K 5/05; C08G 73/128; B01J 31/1616; C08K 5/07

(57) ABSTRACT

Bismaleimide (BMI) and cyanate ester (CE) thermosets were developed for use as high temperature encapsulants and adhesives. These materials must withstand prolonged exposures to large thermal gradients while maintaining good structural integrity, minimal mass losses and outgassing. Bismaleimide and cyanate ester thermosets exhibit superior thermal performance compared to most epoxies and can often tolerate long exposures to temperatures >200° C. without undergoing significant degradation. In addition to excellent stability at elevated temperatures, uncured resins can have good processing attributes, such as, low viscosities and long working times. In particular, specific combinations of BMI and CE resins can provide significantly better thermal performance than the current standard epoxy system in addition to having excellent processing capabilities.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to thermoset polymers and, in particular, to thermoset polymers for high temperature applications.

### BACKGROUND OF THE INVENTION

The susceptibility of common epoxy-based thermosets to pyrolytic degradation when subjected to continuous exposures to temperatures exceeding 150° C. may compromise material lifetime expectations resulting in premature failure. Current epoxy systems used as encapsulants and binder materials have been found to experience substantial pyrolytic degradation resulting in mass losses >5%, significant volatile evolution mainly in the form of combustion products, including water.

Therefore, a need remains for thermoset polymers suitable for high temperature applications and minimal off-gassing.

### SUMMARY OF THE INVENTION

The present invention is directed to a method for synthesizing a bismaleimide thermoset, comprising providing a bismaleimide resin, and curing the bismaleimide resin with a bismaleimide curative. The bismaleimide curative can comprise an allyl, propenyl, or amine curative. The bismaleimide resin can comprise a blend of two or more bismaleimide resins, thereby synthesizing a bismaleimide composite. The invention is further directed to a method of synthesizing a cyanate ester thermoset, comprising providing a cyanate ester resin, and curing the cyanate ester resin with a phenolic hydroxy. The method can further comprise providing a catalyst to aid in the curing step. The invention is further directed to a cyanate ester thermoset comprising a cyanate ester resin crosslinked with a phenolic hydroxy.

Specific combinations of BMI and CE resins can produce significantly better thermal performance than the current standard epoxy system in addition to having excellent processing capabilities. Some BMI and CE polymers possess high glass transition temperatures (T_{g}) with very low shrinkage and volatile evolution even at temperatures >300° C. For example, a formulation of CE resins comprising a high T_{g}, high molecular weight novolac-type cyanate ester blended with a low viscosity, low molecular weight bisphenol E cyanate ester in a 50:50 w/w ratio provided good overall performance in terms of thermal stability, low off-gassing, and processability. Addition of a transition metal chelate catalyst dissolved in nonylphenol was found to reduce cure times and temperatures. The viscosities of both BMI and CE systems can be lowered by gentle heating (ca. 80-100° C.) that facilitates wicking into parts. Working times are typically >30 minutes for CE materials but typically much shorter for BMI systems until gelation begins, and curing is usually accomplished by heating at elevated temperatures (e.g., 200° C.) for approximately one day.

### BRIEF DESCRIPTION OF THE DRAWINGS

The detailed description will refer to the following drawings, wherein like elements are referred to by like numbers.

FIG. 1A shows the chemical structures of bismaleimide (BMI) resins. FIG. 1B shows the chemical structures of BMI curatives.

FIG. 2A shows the crosslinking reaction of the maleimide group of a BMI resin with the allyl group of a diallyl bisphenol A (DABPA) curative. FIG. 2B shows the condensation reaction of DABPA hydroxyl groups to form ether linkages. FIG. 2C shows the crosslinking reaction of the maleimide group of a BMI resin with the substituted styrene group of a TM-123 curative.

FIGS. 3A and 3B are correlation plots of maleimide vs. allyl integrated absorbance in 1.2:1 molar BMI/DABPA (FIG. 3A) and BMPP/DABPA (FIG. 3B), respectively, at 150, 175, and 200° C., showing a nearly 1:1 consumption over time at all temperatures.

FIG. 4A is a plot of near-infrared (NIR) monitoring of C═C consumption in BMI cured with TM123, DABPA, DAEtherBPA, and 1:1 DABPA:DAEtherBPA in a 1.2:1 BMI/Curative molar ratio at 175° C. FIG. 4B is an Arrhenius plot with activation energies of these BMI cure reactions at 125-200° C.

FIG. 5A is a plot of NIR monitoring of 3 different bismaleimide monomers cured with DABPA in a 1.2:1 molar ratio at 175° C. FIG. 5B is an Arrhenius plot with activation energies of these bismaleimide monomers cured with DABPA at 125-200° C.

FIG. 6A is a plot of NIR monitoring of DABPA hydroxyl consumption during cure with 3 different bismaleimide monomers at 175° C. FIG. 6B is an Arrhenius plot with activation energies of DABPA hydroxyl consumption during cure at 125-200° C.

FIG. 7A is a plot of NIR kinetics of hydroxyl consumption from etherification of DABPA during cure of BMI/DABPA. FIG. 7B is a plot of NIR kinetics of hydroxyl formation from Claisen rearrangement of DAEtherBPA resulting in formation of DABPA during cure of BMI/DAEtherBPA. FIG. 7C is a plot of NIR cure monitoring of BMI/(1:1 DABPA:DAEBPA) showing hydroxyl increase due to Claisen rearrangement in parallel with hydroxyl decrease due to ether formation.

FIGS. 8A-8C are plots of isothermal thermogravimetric analysis (TGA) under N₂ at 350 (FIG. 8A), 325 (FIG. 8B), and 300° C. (FIG. 8C) of BMI cured PDODA, TM-123, DABPA, and DAEtherBPA. All BMI materials show significantly better thermal stability compared to 828/1031/DDS.

FIGS. 9A-9C are plots of isothermal TGA at 350° C. under N₂ of 3 different bismaleimide monomers cured with DABPA (FIG. 9A), DAEtherBPA (FIG. 9B), and TM123 (FIG. 9C) in a 1.2:1 molar ratio.

FIGS. 10A-10C are plots of activation energies of pyrolytic degradation of bismaleimide materials at 300, 325 and 350° C., respectively.

FIG. 11A is a plot of isothermal TGA at 350° C. under N₂ of BMI cured with DABPA in 1:1, 1.2:1, and 1.5:1 molar ratios. FIG. 11B is an isothermal TGA plot of BMI cured with TM-123 in 1.2:1, 1.5:1 and 2:1 molar ratios.

FIG. 12 shows the crosslinking reaction of the maleimide group of a BMI resin with an amine curative.

FIGS. 13A-13C are plots of NIR cure monitoring of BMI reacted with 5 different aromatic diamines in a 2:1 molar ratio at 175° C. Cure speed is heavily influenced by amine basicity.

FIG. 14A is a plot of isothermal TGA at 350° C. under N₂ of BMI cured with 5 different aromatic diamines in a 4:1 molar ratio. FIG. 14B is an isothermal TGA plot in a 2:1 molar ratio of BMI/Diamine.

FIG. 15 shows cyanate ester (CE) resins.

FIG. 16A shows the crosslinking reaction of a CR resin with a CR curative. FIG. 16B shows the hydrolysis reaction of water with a CE monomer.

FIG. 17 is an IR-ATR spectra of 50:50 XU-371/AroCyL-10 showing initial unreacted mix (black) as well as cured material after 20 hours at 200° C. under dry nitrogen (green), dry air (blue), and ambient humidity (red). IR bands associated with hydrolysis of CE groups include carbonyl at 1731 cm⁻¹ and amine at ˜3390 cm⁻¹ from carbamate formation. IR cure monitoring at 200° C. (inset) shows significant influence of cure atmosphere. Cure reactions are also highly exothermic.

FIGS. 18A-18C are plots of IR-ATR cure kinetics of uncatalyzed XU-371 (FIG. 18A), 50:50 XU-371/AroCyL-10 (FIG. 18B), and AroCy L-10 (FIG. 18C) at 150, 175, and 200° C.

FIG. 19A is a plot of IR-ATR catalyzed cure kinetics of XU-371, AroCyL-10, and a 50:50 XU-371/AroCyL-10 blend. FIG. 19B is plot of activation energies of cure kinetics for each resin with comparisons of catalyzed and uncatalyzed curing of the 50:50 XU-371/AroCyL-10 blend.

FIG. 20 is a plot of IR-ATR catalyzed cure kinetics of XU-371, AroCyL-10, and a 50:50 XU-371/AroCyL-10 blend and compared to an uncatalyzed cure. Catalyst materials were dissolved in nonyl-phenol (NP).

FIGS. 21A-21C are plots of isothermal TGA under N₂ at 350, 325, and 300° C. of XU-371, PT-30, PT-15, AroCy L-10, and 50:50 XU-371/AroCyL-10. All CE materials show significantly better weight retention compared to 828/1031/DDS.

FIG. 22 is a plot of activation energies of pyrolytic degradation of CE materials at 300, 325 and 350° C.

FIG. 23 shows photographs of AroCy L-10 cured without a catalyst and cut into 3 bar samples which were aged in separate ampoules at 240° C. under N₂ for 28 days. The samples in ampoules 1 and 2 were subjected to essentially identical aging conditions, whereas the sample in ampoule 3 was aged in the vicinity of two BMI materials and one XU-371 material.

FIGS. 24A-24C are graphs comparing water formation yield (FIG. 24A), mass change (FIG. 24B) and length change (FIG. 24C) for all resins at 240° C. for up to 22 days.

FIG. 25 shows photographs depicting color changes to bars of each resin when subjected to aging in dry nitrogen at 240° C. and 22 days.

FIG. 26 is a graph of fracture toughness of thermoset materials (see Table 6 for legend) compared to Epon 828/1031/DDS (material 0).

FIG. 27 is a graph of failure strain of the thermoset materials.

FIG. 28 is a graph of flexural strength of the thermoset materials.

FIG. 29 is a plot of compressive stress-strain responses of the thermoset materials.

### DETAILED DESCRIPTION OF THE INVENTION

Bismaleimides (BMIs) and cyanate esters (CEs) are alternative thermosets which possess significantly higher glass transition temperature T_{g} than epoxies. Likewise, these systems can exhibit greater thermal stability with respect to outgassing and shrinkage. In fact, BMI and CE materials are seeing increased use in the aerospace and electronics arenas due to their ability to withstand high temperatures with very little apparent degradation. Most importantly, their chemistries are much less susceptible to producing unwanted volatile byproducts although additional work is required to determine stability characteristics for a broader range of operating conditions. One potential drawback is that higher cure temperatures are often required but these can be reduced by including small amounts of transition metal complex catalysts with CE systems.

Unlike standard epoxies, the preparation, cure mechanism and formulation design of both BMI and CE systems are not as well developed, as they are still widely considered as niche materials. Cure mechanisms rely on high temperature and often parallel condensation pathways coupled with free radical polymerization, in the case of BMI, or through triazine formation via cyclotrimerization, in the case of CE. The attributes of both thermosets in processing and cured states are amenable to optimization through blending, which can be refined by empirical performance evaluations. Commercial sources for either type of material are also relatively limited compared to epoxies and often much more expensive. However, continued advancements in synthesis design and scaling should result in lower prices and broader applicability. Additional improvements can also be realized through basic characterization and aging studies that can be tailored for specific applications.

The present invention is directed to BMI and CE polymers as alternative encapsulant/adhesive materials for high temperature applications. Mixing ratios of exemplary polymer formulations were optimized not based on exact stoichiometry, but rather their melting, blending, and processing behavior in parallel with thermogravimetric analysis (TGA) measurements to evaluate thermal performance. Initial cure schedules were developed for each of the materials to enable a work time range for processing and extended handling as a wetting and immersion application may require, as well as a subsequent slow reliable stacked cure to yield high T_{g} condensed materials. CE materials do not necessarily require catalysts as they can thermally condense on their own forming a trimer (triazine ring), but some basic catalysts can be used to accelerate their curing and improve cure kinetics.

### Thermal Stability Characteristics of BMI and CE Polymers

Thermoset BMI polymers have been shown to be much more robust compared to epoxy/amine thermosets, exhibiting only 4% weight loss when aged under similar conditions (180° C., atmospheric conditions) for 340 hours (compare with 8% weight loss at 210 hrs for epoxy/amine system under same conditions). See X. Colin et al., Polym. Degrad. Stab. 78, 545 (2002). However, their TGA data did show that upon aging of the BMI material at 180° C., an initial increase in mass is observed prior to the aforementioned mass loss. Thermoset BMI systems are also much more stable than their epoxy/amine counterparts under inert atmosphere, at least in the short-term. TGA experiments under inert atmosphere by Kandola and Torrecillas have shown that whereas epoxy systems thermally degrade around 400° C. (approximate mid-point of degradation), BMI polymers are stable up to 490° (approximate mid-point of degradation). See B. K. Kandola et al., Polym. Degrad. Stab. 95, 144 (2010); and R. Torrecillas et al., Polym. Degrad. Stab. 51, 307 (1996). Additionally, it was shown by Torrecillas that bisnadimides (cyclopentadiene Diels-Alder adduct) were superior still to BMIs in regards to high temperature thermo-oxidative stability though the network structure is less well defined. See J. Fan et al., Polym. Int. 52, 15 (2003).

CE polymers have similar qualities as BMIs and tend to be less susceptible to off-gassing because the polymerization reaction produces no volatile byproducts. Additionally, cured forms are remarkably stable with little to no volatile degradation or loss of T_{g} reported to date. Thermal stability characteristics of some CE polymers noted the formation of carbonaceous char near the reported decomposition temperature which protects the underlying bulk material. While under air operation, thermo-oxidative degradation occurs by hydrolysis in the presence of moisture whereas homolytic cleavage of the backbone linking cyanurate rings was observed at high temperatures (>450-500° C.) under inert conditions. See J. T. Reams et al., ACS Appl. Mater. Interfaces 4, 527 (2012); and J. A. Throckmorton et al., Polym. Degrad. Stab. 151, 1 (2018). IR spectroscopic and mass spectrometry tools provide a clearer picture of mechanistic details. See S. Gouthaman et al., Polym. Int. 68, 1666 (2019).

### BMI Resins and Curatives

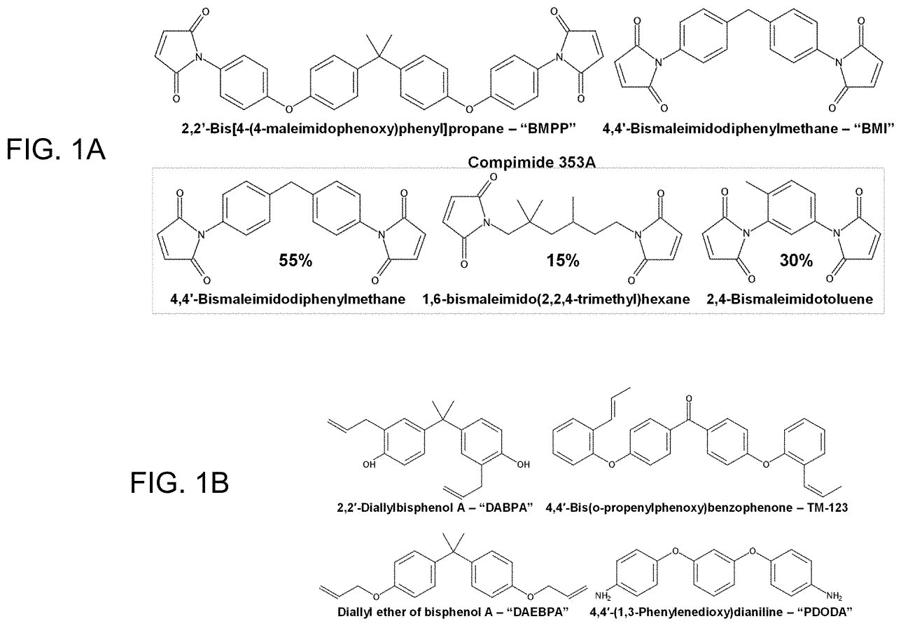

Exemplary BMI precursor resins were selected from commercially available sources using reported T_{g} as a criterion. Below are the principal resins examined along with their chemical structures, as shown in FIG. 1A:
BMI is a generic methylenediphenylbismalemimide commercially available from Huntsman (Matrimid 5292A), Evonik (Compimide MDAB), and other suppliers. Melting point: 157-160° C., Molecular Weight: 358.4 g/mol.
BMPP is a bisphenol A diphenyl ether bismaleimide which commercially available from TCI America. Melting point: 163-167° C., Molecular Weight: 570.6 g/mol.
C353A is a eutectic blend of 3 bismaleimide monomers with exceptional processing characteristics due to its low melting point of ˜80° C. that is commercially available from Evonik (Compimide 353A). Softening point: 80-90° C., Average MW: 325.8 g/mol.
   BMI curatives necessary for the curing polymerization reaction are as follows, with their chemical structures shown in FIG. 1B:
DABPA (2,2′-Diallylbisphenol A) is a commonly used toughening modifier which can be obtained from Huntsman (Matrimid 5292B), Evonik (Compimide TM-124), and other suppliers.
DAEtherBPA or DAEBPA (Diallyl ether of bisphenol A) is a low viscosity toughening modifier typically used as a reactive diluent in combination with other BMI curatives which can be obtained from Huntsman (Matrimid 2292), Evonik (Compimide TM-124E), and HOS-Technik (Homide 126A).
TM-123 (4,4′-Bis(o-propenylphenoxy)benzophenone) is a bispropenyl toughening modifier available from Evonik (Compimide TM-123).
PDODA (4,4′-Phenylenedioxydianiline) is an aromatic diamine containing ether bridging groups which can be obtained from SigmaAldrich and TCI America.

### BMI-Alkenyl Polymerization Chemistry

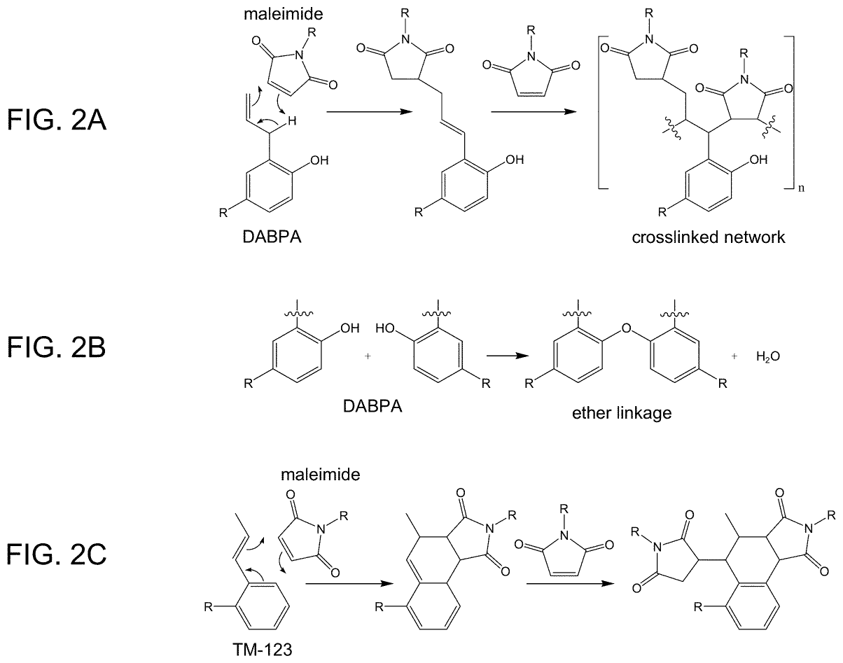

The most commonly used BMI curative is diallyl bisphenol A (DABPA) which reacts with BMI's via a step-wise “ene” addition of the allyl to the maleimide double bond, forming a propenyl group which then reacts with another maleimide group to form a crosslinked network, as shown in FIG. 2A. See S. E. Evsyukov et al., Polym. Adv. Technol. 26, 574 (2015); R. J. Iredale et al., Prog. Polym. Sci. 69, 1 (2017); and M. Satheesh Chandran and C. P. Reghunadhan Nair, in Maleimide-Based Alder-Enes, pp. 459-510 (2014). Based on monofunctional model compound studies it was initially thought that that this crosslinking reaction proceeded via a Diels-Alder addition between the substituted styrene intermediate and a maleimide group. However, Rozenberg showed that this reaction does not occur in the polymerizing system due to stearic hindrance. See B. A. Rozenberg et al., Polym. Adv. Technol. 13, 837 (2003); and R. J. Morgan et al., Polymer 38, 639 (1997). Rozenberg established that propenyl groups generated by “ene” addition react with maleimide groups in a radical chain-growth mechanism. Homopolymerization of maleimide groups also occurs to a limited extent above 200° C.

Another source of crosslinking is the condensation reaction of DABPA hydroxyl groups to form ether linkages coupled with the evolution of water, as shown in FIG. 2B. See J. C. Phelan and C. S. P. Sung, Macromolecules 30, 6845 (1997); and R. J. Morgan et al., Polymer 38, 639 (1997). This dehydration reaction occurs to ˜50% conversion during cure and continues relatively slowly thereafter over extended time at elevated temperature.

TM-123 is hypothesized to react with bismaleimides via an “Alder-ene” reaction sequence, starting with a Diels-Alder addition between a substituted styrene group and a maleimide group, followed by an “ene” addition between the Diels-Alder adduct with another maleimide group, as shown in FIG. 2C.

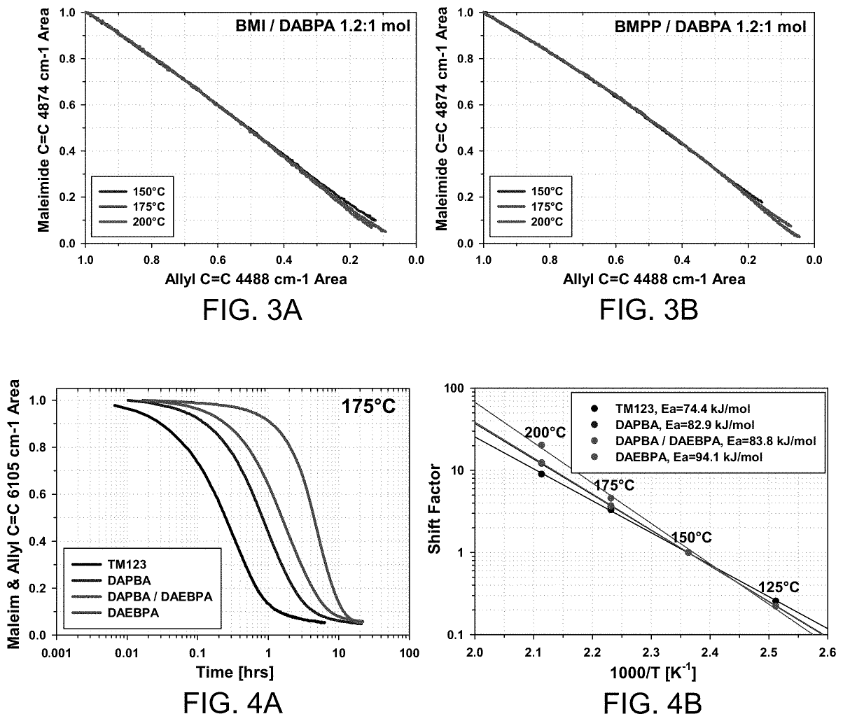

All of the exemplary formulations were prepared in a 1.2:1 molar ratio of bismaleimide resin to curative which is consistent with conventional commercial formulation recommendations for optimal mechanical properties of the cured materials. See R. J. Iredale et al., Prog. Polym. Sci. 69, 1 (2017). Cure kinetics of BMI resins were monitored using near-infrared (NIR) spectroscopy in transmission mode with samples placed in a heated attenuated total reflectance (ATR) stage. Evaluation of isothermal cure kinetic behavior at 150, 175, and 200° C. was accomplished by integrating the IR absorption transitions associated with maleimide C═C stretch (4874 cm⁻¹), allyl C═C stretch (4488 cm⁻¹), as well as a general C═C band (6105 cm⁻¹). The TM-123 propenyl C═C absorption overlaps with maleimide at 6105 cm⁻¹ and therefore cannot be quantified independently. As shown in FIGS. 3A and 3B, consumption of maleimide and allyl double bonds proceeds in a nearly 1:1 ratio in BMI/DABPA and BMPP/DABPA, which indicates that alternating copolymerization between the two monomers is the dominant crosslinking chemistry whereas maleimide homopolymerization appears to be minimal.

Relative cure rates in terms of the time to reach 50% conversion at 150, 175, and 200° C. are given in Table 1 for the three BMI curatives and kinetic data is displayed in FIGS. 4A and 4B. Out of the three curatives, TM-123 has the shortest processing window since it cures with BMI nearly ˜4 times faster than DABPA at 150° C. DAEtherBPA (DAEPBA) is by far the slowest to cure with BMI, making it an attractive reactive diluent due to its very low viscosity and potential to extend the processing window when combined with other BMI curatives. However, DAEtherBPA was found to be quite volatile at cure temperatures of 150° C. and above, therefore it is best used as a viscosity-reducing additive for initial cure temperatures around 125° C.

TABLE 1
Summary of cure kinetics of BMI resins.

| | BMI/Curative (1.2:1 molar) | | |
|---|---|---|---|
| | Time to 50% conversion (hours) | | |
| Curatives | 150° C. | 175° C. | 200° C. |
| TM-123 | 0.8 | 0.25 | 0.09 |
| DABPA | 3.0 | 0.82 | 0.25 |
| 1:1 DABPA/DAEBPA | 5.8 | 1.58 | 0.47 |
| DAEtherBPA | 20 | 4.50 | 1 |

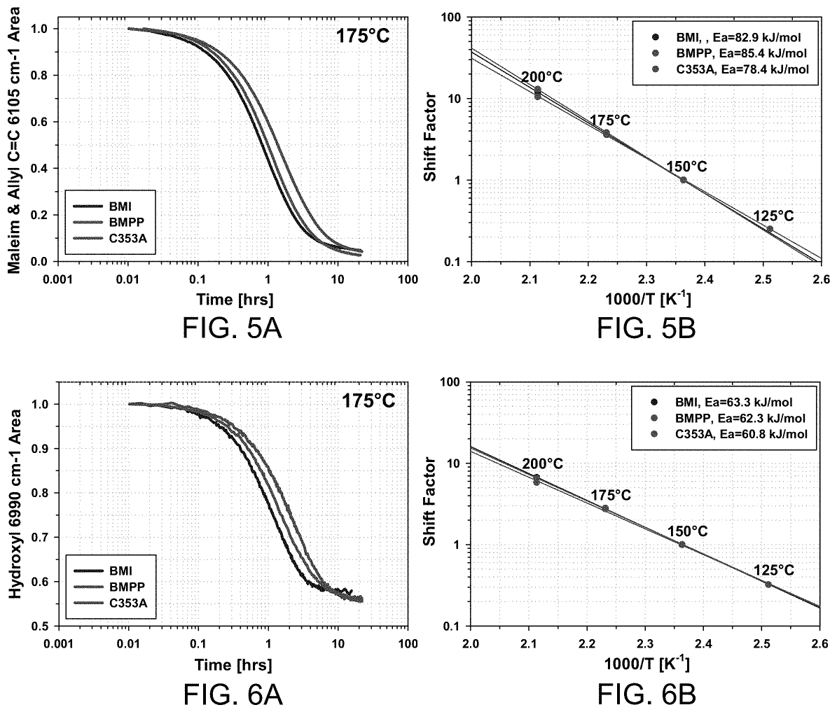

The effect of BMI resin was evaluated at 175° C. by tracking both the 6105 cm⁻¹ C═C mode and hydroxyl mode at ca. 6990 cm⁻¹ using NIR transmission spectroscopy. While the 3 different curatives showed quite different kinetic behavior (FIGS. 4A and 4B), the structure of the bismaleimide monomer was found to have less of an effect on cure speed, as shown in FIGS. 5A and 5B. BMPP cures ˜1.7 times slower with DABPA compared to BMI, which is likely due to the effective dilution of maleimide groups per volume of resin in the higher Mw BMPP monomer. Homopolymerization of pure bismaleimide reveals significant differences between the kinetic behavior of the 3 bismaleimide monomers. Homopolymerization of pure BMI at 175° C. is ˜156 times faster than pure BMPP and only reaches ˜50% conversion after 10 hours due to limited molecular mobility as a result of very high crosslink density.

The condensation reaction of DABPA hydroxyl groups to form ether linkages is evidenced by a decrease in the hydroxyl band centered at 6690 cm⁻¹, shown in FIGS. 6A and 6B. Cure studies in the mid-IR region corroborate the presence of this parallel reaction by the appearance of a strong ether absorption at 1165 cm⁻¹ (data not shown). This dehydration reaction results in the release of water which may theoretically increase the risk of void formation during cure, however, none of the DABPA-cured materials showed any evidence of bubbles or voids. See G. Fischer, in High temperature and toughened bismaleimide composite materials for aeronautics, Materials, Universite de Lyon (2016). NIR monitoring of the hydroxyl band during cure shows a nearly 50% reduction in OH after a standard cure cycle, which would occur in parallel with a release of 1 water per total resin mass. Moreover, NIR is quite sensitive to dissolved water and a 1% loading would produce a strong absorption at 5250 cm^{-1,} however, no significant increase in this band was observed during the cure of BMI/DABPA, which suggests that water diffuses rapidly out of the matrix after it is formed.

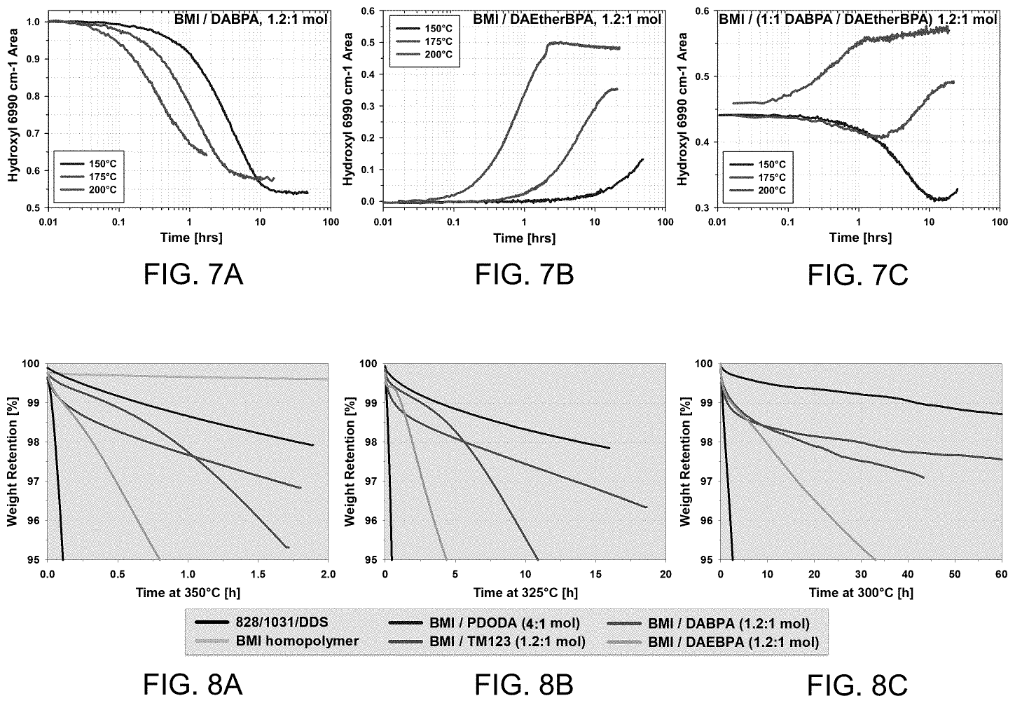

Additional views of the cure kinetics of BMI with DABPA, DAEtherBPA, and a 50:50 blend of each are shown in FIGS. 7A-7C, respectively. These data were obtained by monitoring the hydroxyl OH overtone stretch which reveal stark differences in OH production during curing. DAEtherBPA, which has no hydroxyl group, shows significant formation of hydroxyls during cure due to a Claisen rearrangement reaction that converts DAEtherBPA to DABPA. The Claisen rearrangement reaction, as evidenced by an increase in the hydroxyl band, was also found to occur in pure DAEtherBPA when heated above 150° C. These features indicate that this curative or any combination thereof is potentially unstable for long durations at elevated temperatures.

### BMI-Alkene Thermal Stability Characteristics

The thermal stability of BMI materials cured with allyl and propenyl compounds was assessed with isothermal TGA at 300, 325, and 350° C. under nitrogen. Isothermal aging was preceded by a drying step of 1 hour at 150° C. followed by a 20° C./min ramp to the appropriate aging temperature. FIGS. 8A to 8C present the thermal performance of 4 different BMI-curatives which are compared alongside a common epoxy system (Epon 828/1031/DDS, a 50:50 blend of epoxy resins Epon 828 and Epon 1031, cured with 4,4′-diaminodiphenylsulphone (DDS)) under similar conditions. It is immediately apparent that all BMI materials showed significantly better thermal stability compared to the Epon 828/1031/DDS material. Furthermore, the BMI homopolymer shows essentially zero weight loss after multiple hours at 350° C., although it is a very brittle material due to its high crosslink density. Initial TGA data suggested that BMI/DAEtherBPA was the most thermally stable material in the series, however, the original samples lost a significant amount of DAEtherBPA to evaporation during cure at 150° C. and therefore had higher BMI content. New BMI/DAEtherBPA samples cured initially at 125° C. to minimize evaporation and then post-cured at 240° C. had the poorest thermal stability out of the 4 curatives in the series, although still performed much better than the epoxy material. BMI cured with PDODA in a 4:1 molar ratio is the next most thermally stable after the BMI homopolymer, although it has a very limited processing window and is prone to void formation. BMI materials cured with TM-123 or DABPA show excellent thermal performance which can be further improved by increasing the content of BMI.

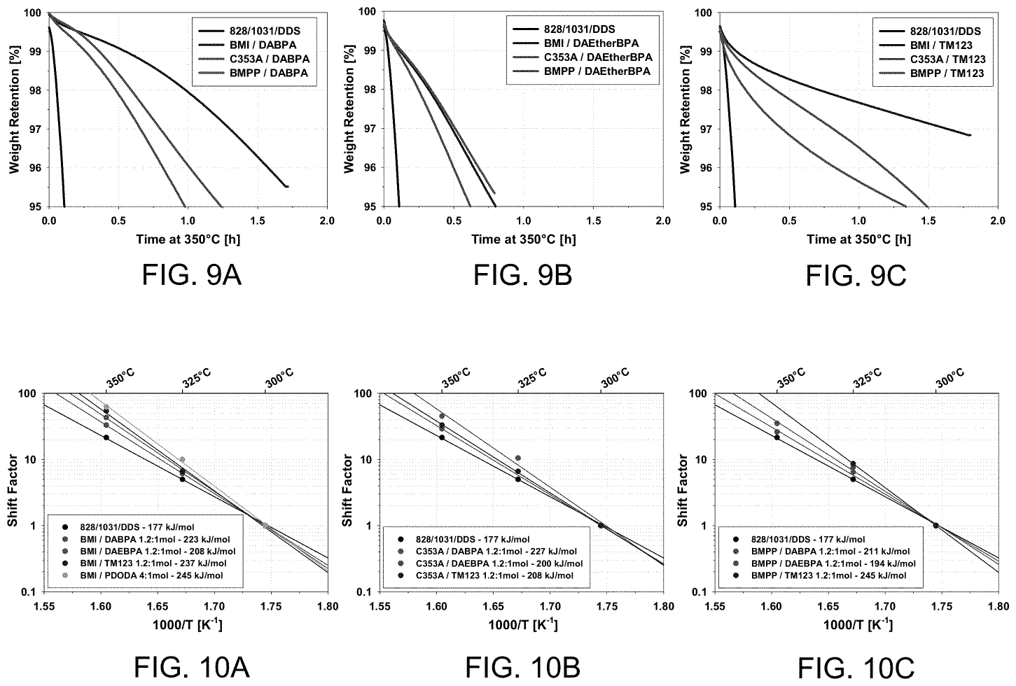

The effect of BMI monomer cured with the DABPA additive were determined, as shown in FIGS. 9A-9C. Out of the 3 monomers, BMI was found to be the most thermally stable when cured with DABPA or TM-123, which can be attributed to its higher crosslink density compared to BMPP, and higher aromatic content compared to C353A.

As shown in FIGS. 10A-10C, all BMI materials that were screened displayed Arrhenius behavior with regard to weight loss vs. time in the 300-350° C. temperature range, although the TM-123 cured materials showed some small deviation at 300° C. Eₐ values were calculated by obtaining shift factors from time-temperature superpositions of weight loss vs. temperature at 300, 325, and 350° C. (the shift factor is the horizontal shift between these curves at the different temperatures). Assuming Arrhenius aging behavior from 350° C. down to 160° C., it would take 7280 years at 160° C. for the BMPP/DABPA material to lose 5% of its weight, compared to only 42 years for the Epon 828/1031/DDS material. It should be noted that extrapolations of this magnitude from very high to lower temperatures should be used as initial guidance only since mechanistic changes in aging behavior at different temperature regimes are known to exist for many materials, causing significant deviations from Arrhenius behavior at lower temperatures. See M. C. Celina, Polym. Degrad. Stab. 98, 2429 (2013); and R. A. Assink et al., Symposium on Polymer Performance and Degradation held at Pacifichem 2005 Conference (Honolulu, HI), pp. 26-36 (2005).

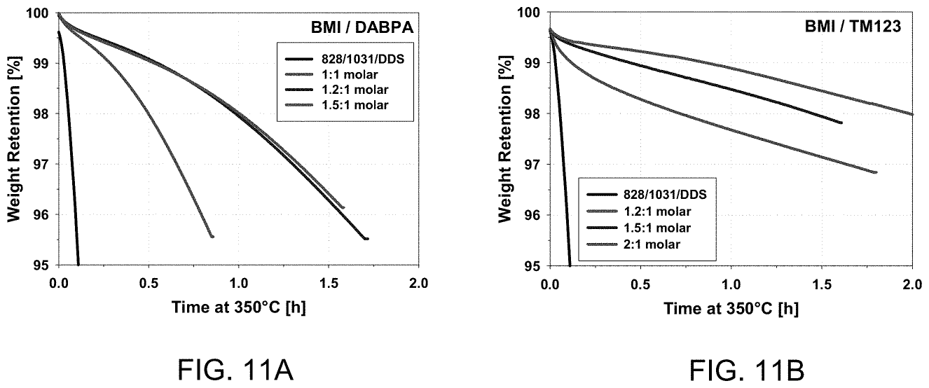

BMI cured with DABPA or TM123 showed the most promise for high temperature applications in terms of very low weight loss and favorable cure behaviors. The effect of curative loading on weight retention characteristics was next determined from TGA measurements. FIGS. 11A-11B shows TGA results as a function of each curative loading. For DABPA, no change was observed >1.2:1 molar ratios whereas TM123 improved with larger loading. While encouraging, shelf-life and workability for each combination were less desirable. Specifically, viscosities were high and evidence of early curing was observed.

### BMI-Amine Materials

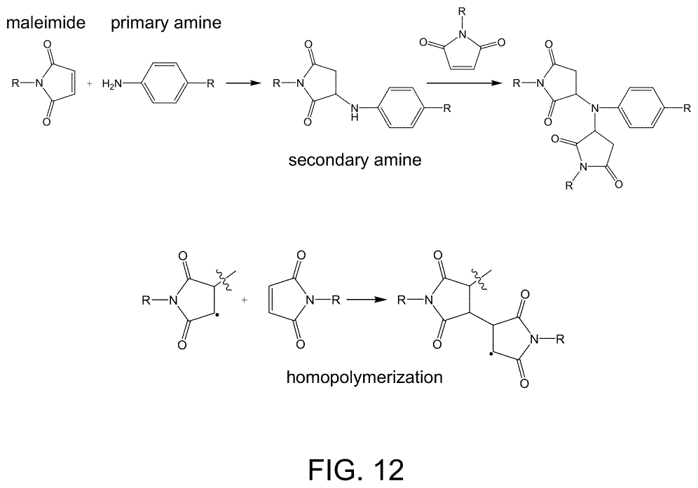

Like epoxies, BMI systems can also be cured with amines. Copolymerization of BMI resins with diamines proceeds via a Michael addition reaction. See R. J. Iredale et al., Prog. Polym. Sci. 69, 1 (2017); J. Zhu, in Curing behavior and properties of 4,4′-bismaleimidodiphenylmethane and o,o′-diallyl bisphenol a: effect of peroxides and hybrid silsesquioxane addition, Ph. D. Thesis, Michigan State University (2013); and J. L. Hopewell et al., Polymer 41, 8221 (2001). The first step is a chain extension reaction of a maleimide with a primary amine, followed by a crosslinking reaction of a maleimide with the secondary amine generated by the first reaction, as shown in FIG. 12. Since the secondary amine has been shown to be less reactive than the primary amine, homopolymerization of maleimide groups is an important source of additional crosslinking.

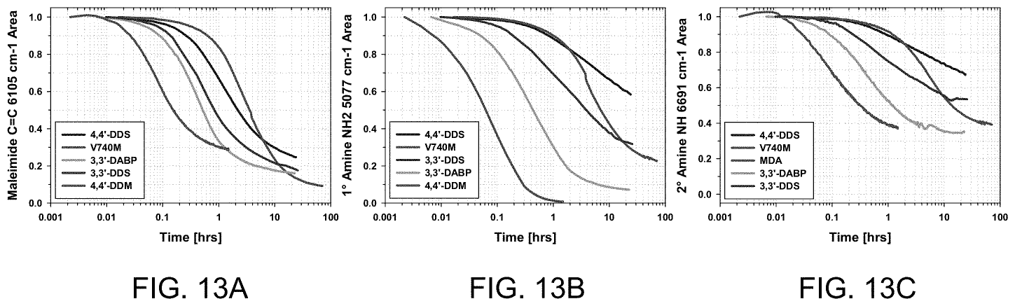

Five different aromatic amine curatives shown in Table 2 were studied and the cure kinetics results are shown in FIGS. 13A-13C. PDODA was originally selected as an amine curative for BMI due to its relatively low melting point and potential to enhance material toughness, however, the resin blend was found to have insufficient pot life and tended to produce volatiles during cure. Alternative aromatic diamines with lower reactivity were pursued in order to improve pot life and minimize void formation.

Exemplary resin mixes were prepared in a 2:1 molar ratio of BMI to diamine monomer, which in terms of stoichiometry is equivalent to a 1:1 molar ratio of maleimide groups to amine hydrogens. NIR cure monitoring at 175° C. verified that as with epoxy-amine cured materials, amines with the lowest basicity (4,4′-DDS, 3,3′-DDS, and V470M) were the slowest to cure and still had excess unreacted primary amine groups even after post curing at 240° C. for several hours. Amines with higher basicity (3,3′-DABP and 4,4′-DDM) reached full consumption of primary amine groups after post cure, but still had excess unreacted secondary amine. NIR cure monitoring of PDODA at 175° C. was not possible due significant volatile formation during cure, resulting in a foam-like material that scattered the NIR beam. Out of the 5 alternative aromatic diamines, 3,3′-DABP was found to be the best compromise in terms of slowing down the cure speed while still maintaining relatively high amine conversion.

TABLE 2
Aromatic diamine curatives.

| | | α[t]=0.5 | m.p. | | Eₐ |
|---|---|---|---|---|---|
| Aromatic Diamine | pKa | at 150° C. | [° C.] | MW | (kJ/mol) |
| 4,4′-Diaminodiphenyl sulfone (4,4′-DDS) | 1.24 | 45 mins | 175-177 | 248.3 | 67.1 |
| 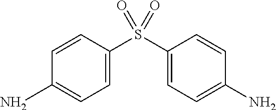 [SMILES: Nc1ccc(S(=O)(=O)c2ccc(N)cc2)cc1] | | | | | |
| 1,3-Propanediol-bis(4-aminobenzoate) | 2.61 | 25 mins | 124-127 | 314.3 | 70.7 |
| Tradename: Versamid 740M | | | | | |
| 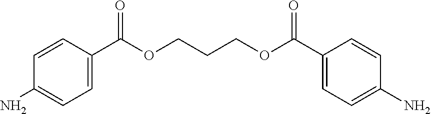 [SMILES: Nc1ccc(C(=O)OCCCOC(=O)c2ccc(N)cc2)cc1] | | | | | |
| 3,3′-Diaminodiphenyl sulfone (3,3′-DDS) | 3.16 | 18.9 mins | 170-173 | 248.3 | 57.6 |
| 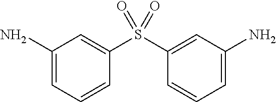 [SMILES: Nc1cccc(S(=O)(=O)c2cccc(N)c2)c1] | | | | | |
| 3,3′-Diaminobenzophenone (3,3′-DABP) | 3.59 | 8.9 mins | 149-156 | 212.3 | 52.3 |
| 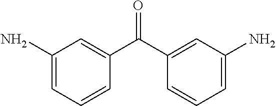 [SMILES: Nc1cccc(C(=O)c2cccc(N)c2)c1] | | | | | |
| Bis[4-(4-aminophenoxy)phenyl]sulfone (p-BAPS) | 4.54 | 4.8 mins | 194-197 | 432.5 | — |
| 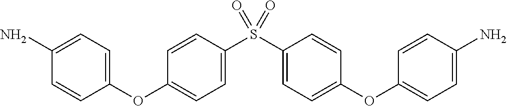 [SMILES: Nc1ccc(Oc2ccc(S(=O)(=O)c3ccc(Oc4ccc(N)cc4)cc3)cc2)cc1] | | | | | |
| 3,4-Oxydianiline (3,4-ODA) | 4.78 | 4 mins | 67-71 | 200.2 | 48.1 |
| 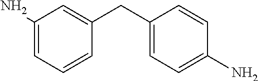 [SMILES: Nc1ccc(Cc2cccc(N)c2)cc1] | | | | | |
| 4,4′-(1,3-Phenylenedioxy)dianiline (PDODA) | 5.06 | 4 mins | 115-119 | 292.3 | — |
| 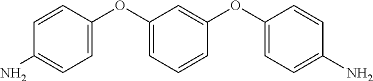 [SMILES: Nc1ccc(Oc2cccc(Oc3ccc(N)cc3)c2)cc1] | | | | | |
| 4,4′-Methylenedianiline (4,4′-MDA) | 5.32 | 2.5 mins | 89 | 198.3 | 47.4 |
| 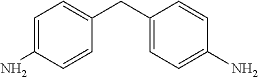 [SMILES: Nc1ccc(Cc2ccc(N)cc2)cc1] | | | | | |

### BMI-Amine Thermal Stability Characteristics

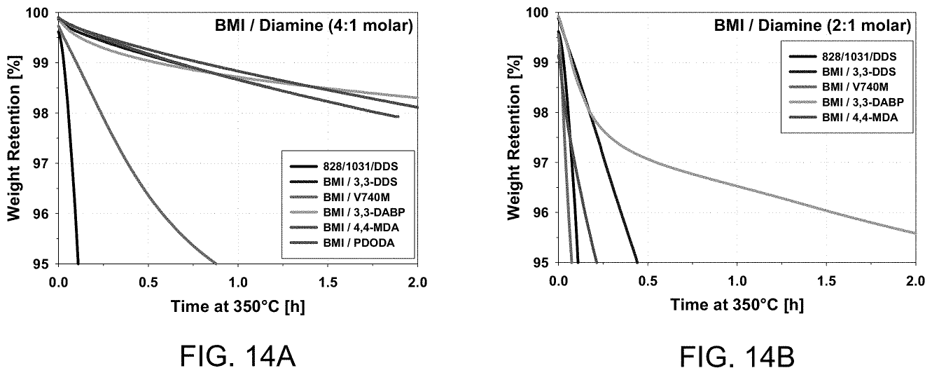

The thermal stability of 5 different aromatic diamine curatives was assessed with isothermal TGA at 350° C. under nitrogen, as shown in FIGS. 14A and 14B. Sample materials were prepared in 4:1 and 2:1 molar ratios of BMI to diamine monomer, which in terms of stoichiometry is equivalent to 2:1 and 1:1 molar ratios of reactive groups respectively. As expected, the 4:1 molar ratio materials showed significantly better thermal stability compared to the 2:1 molar ratio materials which were either worse or only slightly better than the Epon 828/1031/DDS material, with the exception of 3,3′-DABP which had good thermal performance at the 2:1 molar ratio. Aside from V740M which contains an aliphatic backbone structure that reduces its thermal stability, the 4 other diamines did not differ significantly in terms of thermal performance at the 4:1 molar ratio.

### Summary of BMI Thermosets

Overall, BMI thermosets offer markedly improved thermal stability with respect to weight loss although some potential issues were noted with curatives and processability. BMI processing is particularly sensitive to temperature and environment which may place unwanted limitations on viscosity for certain applications. Higher viscosities and shorter working times were observed before the onset of gelling and vitrification. This was alleviated somewhat by homopolymerization although significantly longer cure times and higher temperatures were needed to complete conversion. Mechanical properties were also less desirable with the cured states being especially brittle unless toughener additives were incorporated. See J. M. Barton et al., Polym. Bull. 27, 163 (1991). Lastly, most BMI resins have a strong odor thus requiring all operations be carried out in a fume hood or well-ventilated space.

### Cyanate Ester Resins and Curatives

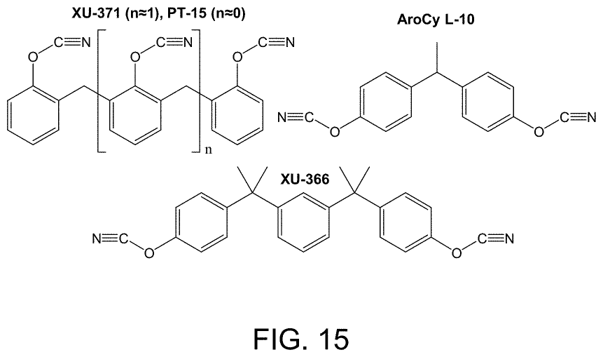

Exemplary CE resins were selected based on T_{g} and viscosity in the monomer state, as shown in FIG. 15. CE resins can be blended to tune desired viscosity and cured state properties but details of the stabilities and shelf-life of these composites over long time periods is not well understood. As an example, 50:50 blends of the higher viscosity and T_{g} XU-371 resin with the much lower viscosity AroCyL-10 resin were examined. This strategy was sought to incorporate better processability with improved high temperature performance in a CE composite. This ability to combine CE resins gives them significant advantages over other thermosets.
XU-371 is a higher MW (˜381 g/mol) methylene-bridged trifunctional phenol derivative commercially available from Huntsman (XU-371) and Lonza (Primaset PT-30).
PT-15 is a lower MW (˜191 g/mol) methylene-bridged difunctional phenol derivative commercially available from Lonza (Primaset PT-15).
AroCy L-10 is a bisphenol E cyanate ester, a very low viscosity difunctional monomer commercially available from Huntsman and Lonza (LECy).
XU-366 is a bisphenol M cyanate ester available from Huntsman.

### CE Polymerization Chemistry

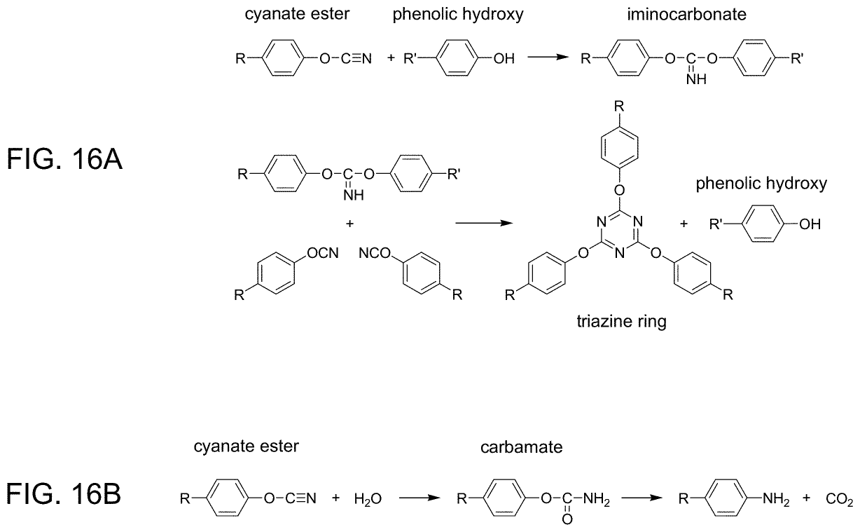

CE polymerization is initiated by the reaction of a phenolic hydroxyl with a cyanate ester group to form an iminocarbonate intermediate which then undergoes a cyclotrimerization reaction with two more cyanate ester groups to form a triazine ring in a reaction that regenerates the phenolic initiator, as shown in FIG. 16A. Commercial CE resins contain phenolic impurities from the monomer synthesis and can therefore be cured at sufficiently high temperatures (150-200° C.) without the addition of a catalyst. However, most commercial formulations include a trimerization catalyst consisting of a transition metal chelate, such as cobalt(II) acetylacetonate (acac), dissolved in nonylphenol in order to facilitate curing at lower temperatures. This additive also has the benefit of lowering the risk of water uptake during cure by decreasing the total cure time. See J. T. Reams et al., ACS Appl. Mater. Interfaces 4, 527 (2012); H. Cao et al., Appl. Sci. 9(11), 2365 (2019); R.-H. Lin et al., J. Appl. Polym. Sci. 94, 345 (2004); and J. Wippl et al., Macromolecul. Mater. Eng. 290, 657 (2005). Water can hydrolyze CE monomers to form carbamate groups which undergo decomposition at typical post-cure temperatures >180° C., as shown in FIG. 16B. See J. A. Throckmorton et al., Polym. Degrad. Stab. 151, 1 (2018). Hydrolysis of CE groups during cure can result in final materials with lower crosslink density and therefore lower T_{g}, reduced mechanical performance, and poor thermal stability. Therefore, it is critical to limit exposure of CE resins to moisture and to avoid trimerization catalysts that are known to accelerate hydrolysis, such as zinc octoate.

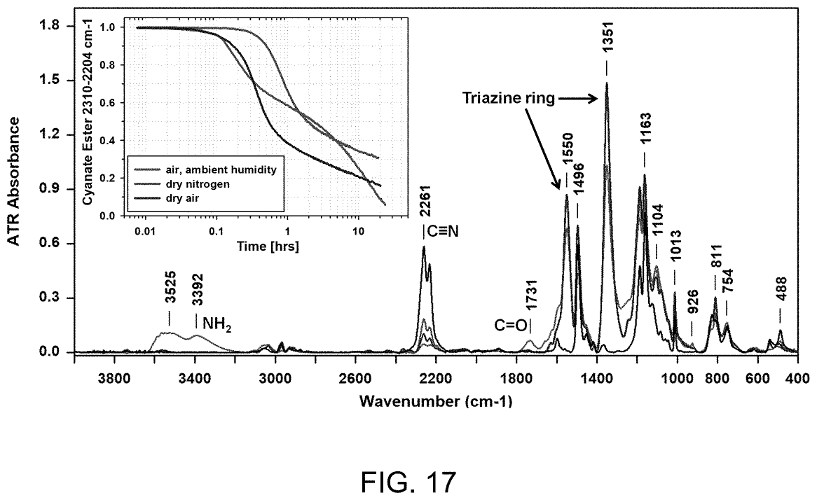

Cure kinetics of the selected CE resins were monitored using mid-IR absorption spectroscopy with monomer resin samples placed on a heated ATR stage. Evaluation of isothermal cure kinetic behavior at 150, 175, and 200° C. was accomplished by integrating the CEN stretching absorption centered at ˜2250 cm⁻¹ and referencing to a p-substituted aromatic deformation band at 1014 cm⁻¹. FIG. 17 shows mid-IR spectra of an uncatalyzed CE composite (XU-371/AroCyL-10, 50:50) cured at 200° C. with the monomer spectrum shown for comparison. Interestingly, cure kinetic behavior was sensitive to the gas composition of the surrounding atmosphere such that resins held under dry air cured much faster and reached a higher conversion than those under dry nitrogen (FIG. 17, inset). The emergence of the triazine C≡N ring stretching mode is apparent concomitant with disappearance of the CEN stretch of the monomer. Under ambient humidity at 200° C., significant CE hydrolysis was evident by the appearance of carbonyl (˜1732 cm⁻¹) and amine (˜3390 cm⁻¹) bands due to carbamate formation along with near complete consumption of cyanate groups coupled with relatively low triazine formation (1550 and 1350 cm⁻¹). CE cure kinetics are also heavily influenced by the presence of trace contaminants such as phenols and amines which can have catalytic activity.

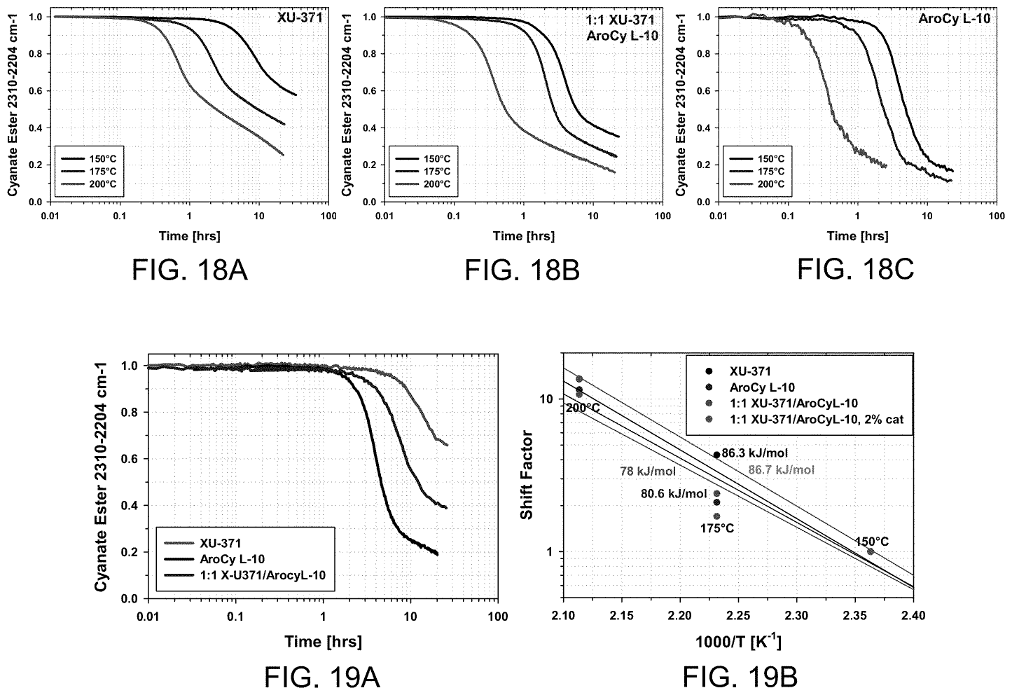

FIGS. 18A-18C compare uncatalyzed cure kinetics of three CE materials at 150, 175, and 200° C. Importantly, monomer functionality strongly influences the conversion level at which vitrification occurs, as evidenced by the relatively early onset of diffusion-controlled kinetic behavior in the trifunctional XU-371 compared to the difunctional AroCy L-10. The later exhibits sharper turn-on behavior compared to the former and earlier in time which is consistent with its lower viscosity. Consequently, the onset of diffusion-limited polymerization at relatively low conversion fraction (ca. 40%) requires an extended high temperature (˜240° C.) post-cure to bring XU-371 to full conversion. The 50:50 blend of XU-371 and AroCy L-10 shows a later onset of diffusion-limited curing of ca. 60% conversion as expected from the presence of the latter.

The addition of a catalyst accelerates the cure reaction only up to vitrification, at which point the reaction rate becomes diffusion controlled. A large variety of catalysts exist, such as tertiary amines, imidazoles, ureas, and transition metal chelates/carboxylates which are by far the most common. Ultimately cobalt(II) acetylacetonate dissolved in nonylphenol was chosen since it has been shown to have high activity even at low very concentrations and does not significantly promote hydrolysis like other metal ions, such as zinc. Comparisons of curing kinetics for the XU-371, AroCyL-10, and a 50:50 XU-371/AroCyL-10 blend resins are shown in FIGS. 19A and 19B. Cure activation energies were estimated and an increase was observed in the 50:50 XU-371/AroCyL-10 blend when the catalyst was added. It is not immediately clear why this is the case although an increase in the shift factor was also present, indicating shorter latency.

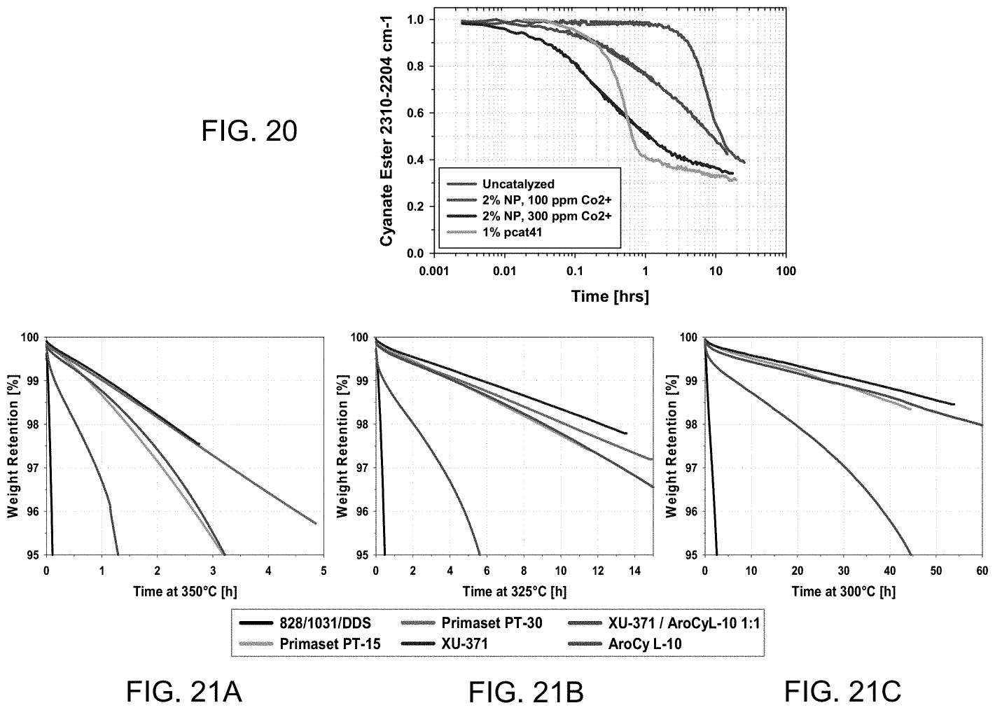

The effect of Co²⁺(acac)₂ catalyst loading on the cure behavior of the 50:50 XU-371/AroCyL-10 blend was examined using IR-ATR spectroscopy and shown in FIG. 20. Increasing catalyst loading expedites curing although the impact of the catalyst on the stability of the cured material is not yet known. Comparing workability and cure onset behavior, it was decided that a Co(acac)₂ concentration of 200 ppm in NP provided the best characteristics.

### CE Thermal Stability Characteristics

The thermal stability of 5 different cyanate ester materials was assessed with isothermal TGA at 300, 325, and 350° C. under nitrogen, as shown in FIGS. 21A-21C. The XU-371 and PT-30 trifunctional phenolic CE materials were the best performers in terms of thermal stability out of all CE materials tested. AroCyL-10 had the lowest weight retention yet performed significantly better than the standard Epon 828/1031/DDS material. This system has desirable workability traits, such as very low viscosity which imparts excellent wicking and long processing times at RT. When combined with high T_{g} (more viscous) CE resins, the properties are essentially linear combinations of each component. Namely, the 50:50 blend had a T_{g} approximately midpoint between the T_{g}'s of the cured monomers, while its thermal stability was much closer to that of XU-371. PT-15 showed similar thermal stability but was much more viscous. Despite the promise of AroCyL-10 in composites, there were some concerning behaviors related to dimensional stability and tends to undergo rapid volume expansion after some amount of aging time.

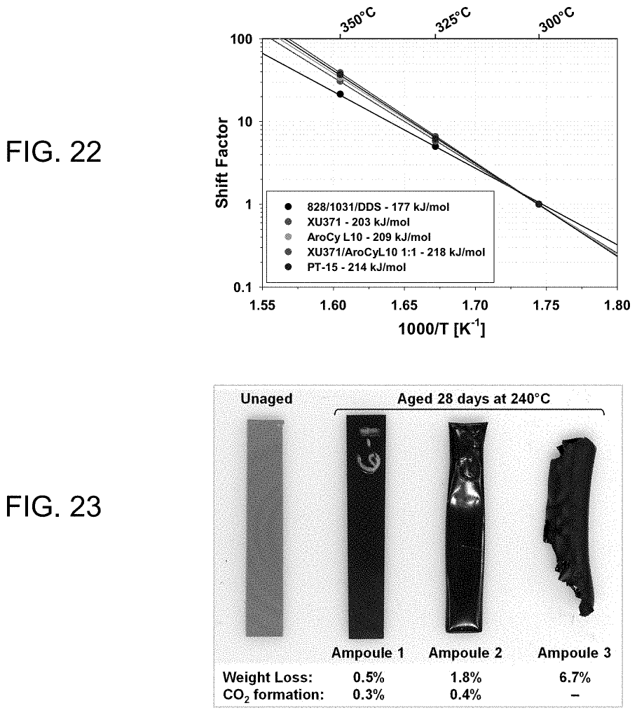

Eₐ values estimated for CE weight losses at constant temperature are shown in FIG. 22. Similar to trends in FIGS. 21A-21C, these values are significantly larger than those found in Epon 828/1031/DDS (ca. 20%) consistent with improved stability, confirming the substantially better thermal stability characteristics seen in both BMI and CE materials. Although AroCyL-10 offers improved processability, some thermal stability issues were noted in its native form. In earlier studies, unexpected weight losses were noted but results were not consistent across samples. Furthermore, an unexpectedly rapid loss of adhesive strength for AroCyL-10 has been observed after 2 weeks of thermal aging at 230, 250, and 260° C. which was accompanied by substantial material vaporization. See J. A. Throckmorton et al., Polym. Degrad. Stab. 151, 1 (2018); and M. L. Ramirez et al., Thermal Decomposition of Cyanate Ester Resins, US Department of Transportation (2001). These authors speculated that the presence of the Co²⁺ catalyst may have contributed to increased degradation at lower temperatures, however, similar rapid degradation behavior was observed in AroCyL-10 cured without a catalyst during aging at 240° C.

These behaviors are portrayed in FIG. 23 with three different AroCyL-10 samples (cut from the same bulk material) that were aged in separate ampoules at 240° C. under nitrogen for 28 days. The degradation behavior of AroCyL-10 was found to be quite sensitive to the aging environment, as evidenced by significantly different weight loss and dimensional stability in these 3 samples. Namely, two of the samples were aged in identical clean ampoules used for IR gas analysis while the third was aged in a large ampoule which also contained three other materials, BMI/DABPA, BMI/Tactix, and XU-371, with each sample weighing approximately 1 gram. For the two samples aged under essentially identical conditions, the two gas analysis samples showed very different aging behavior: one sample exhibited good dimensional stability and weight retention (0.5% loss), while the other formed large blisters and lost ˜1.8% of its weight. A cursory IR gas analysis showed slightly higher CO₂ formation in the more degraded sample, but otherwise no obvious discrepancies were apparent (both had some CO, trace CH₄ and H₂O). On the other hand, the aging behavior of the third sample was clearly accelerated by the presence of the other three materials, as evidenced by its substantial volume expansion accompanied by char formation and higher weight loss. By comparison, the other three materials did not exhibit any unexpected aging behavior.

While it is known that CE materials can experience blistering and discoloring when heated >200° C. in the presence of moisture, the anomalous aging phenomena observed in cured AroCyL-10 bars in FIG. 23 cannot be explained by such a mechanism. See J. T. Reams et al., ACS Appl. Mater. Interfaces 4, 527 (2012). These behaviors raise potential issues for its use in high temperature applications yet, in the 50:50 blends with XU-371, thermally induced weight loss and contraction was minimal compared to homopolymerized XU-371 after aging at 240° C. for 22 days under nitrogen. On related note, the difunctional novolac-based PT-15 had similar weight retention as the 1:1 XU-371/L-10 blend, however, it appears to be less dimensionally stable, expanding in width by 1.8% after 22 days at 240° C.

### Summary of CE Thermosets

CE materials offer significant promise as high temperature thermosets and can be polymerized relatively quickly by adding a small amount of catalyst. Moreover, they do not require curative in stoichiometric amounts which reduces the likelihood of introducing unwanted contaminants or producing labile groups. However, greater sensitivity to the aging environment was apparent, particularly the presence of moisture or other volatile degradation products. This aspect only appears to be a factor for the AroCyL-10 system, but it does raise a level of uncertainty in any life-time prediction made for an application environment that significantly differs from accelerated aging test conditions.

### Comparing BMI and CE Thermoset Stability Characteristics

To briefly summarize the BMI and CE thermoset attributes: when considering resistance to thermally induced weight loss, XU-371 and PT-30 CE resins showed the best overall performance. Only homopolymerized BMI showed slightly better weight retention although the cured form is very brittle material without a toughening modifier. This aspect would likely preclude its use in most encapsulant binder applications in addition to substantially longer cure times and higher temperatures. While not nearly as brittle as homopolymerized BMI, cured phenolic CE has a comparable T_{g} but only about half the fracture toughness of bisphenol-A CE (BADCy) and nearly a third of the fracture toughness of bisphenol-E CE (AroCy L-10). Clearly, a tradeoff in the ultimate T_{g} and material toughness is warranted in addition to processability where higher intrinsic T_{g} always correlates with higher viscosity. Therefore, the ability to combine resins to fine-tune desired properties is preferable for high temperature applications. For example, a 50:50 blend of XU-371 with AroCy L-10 by weight exhibits a good balance between toughness and thermal stability. This composite material also has excellent processing attributes with relatively low viscosity and long working times.

### Correlating Dimensional Stability, Off-Gassing Products and Viscosity Across All Thermoset Materials

Table 3 lists all BMI and CE materials compared in this study and their composition (inc. catalyst). Table 4 summarizes the basic viscosity and cure behaviors across these systems with respect to the Epon 828/1031/DDS reference.

TABLE 3
Summary of BMI, CE and epoxy systems.

| | Mix ratio (mass) |
|---|---|
| Bismaleimide/Diallyl BPA/Amine | |
| BMI/DABPA 1.2/1 molar | 1.4:1 |
| BMI/DAEtherBPA 1.2/1 molar | 1.4:1 |
| BMI/PDODA 2:1 molar | 4.9:1 |
| BMI/TM-123 1.2:1 molar | 0.96:1 |
| BMPP/DAEther-BPA 1.2:1 molar | 2.22:1 |
| BMPP/TM-123 1.2:1 molar | 1.53:1 |
| C353A/DAEtherBPA 1.2:1 molar | 1.25:1 |
| C353A/TM-123 1.2:1 molar | 0.86:1 |
| Cyanate Esters | |
| XU371/AroCy L-10 plus 2% catalyst mix | 50:50 |
| XU371 pure plus 2% catalyst mix | pure |
| Primaset PT-15 pure plus 2% catalyst mix | pure |
| Epon 828/1031/DDS system (Reference) | |

TABLE 4
Wicking behavior and viscosities of BMI and CE resins.

| | | | | Cure viscosity time |
|---|---|---|---|---|
| Sample | | T_{g} | Wicking | to 1 Pa-s (min) @ |
| # | Sample Name | (° C.) | Results | 155° C. |
| Ref | 828/1031/DDS | 253 | Ref | 25 |
| 1 | BMI/DABPA | 285 | Fastest | 36 |
| 2 | BMI/DAEtherBPA | 245 | Fastest | <1 Pa-s within 1 h |
| 3 | BMI/TM-123 | 281 | Faster | 17 |
| | | | than Ref | |
| 4 | C353A/DAEtherBPA | 231 | Faster | <1 Pa-s within 1 h |
| | | | than Ref | |
| 5 | C353A/TM-123 | 217 | Faster | 26 |
| | | | than Ref | |
| 6 | BMPP/DAEtherBPA | 229 | Faster | <1 Pa-s within 1 h |
| | | | than Ref | |
| 7 | BMPP/TM-123 | 242 | Slower | 23 |
| | | | than Ref | |
| 8 | BMI/PDODA | 379 | — | 7.1 |
| 9 | XU371 pure plus 2% | 405 | Slightly | 10 |
| | catalyst mix | | Slower | |
| | | | than Ref | |
| 10 | XU371/AroCy L-10 | 323 | Fastest | 15 |
| | 1:1 plus 2% catalyst | | | |
| | mix | | | |
| 11 | Primaset PT-15 pure | 291 | Faster | 28 |
| | plus 2% catalyst mix | | than Ref | |

### Isothermal Screening of Gas Evolution

Samples for eleven exemplary encapsulation materials were prepared and aged at 240° C. for 22 days and then compared to the reference Epon 828/1031/DDS material. Preliminary studies of volatile evolution during aging were examined with a mid-IR technique and calibrated against known standards. In parallel, the weight and dimensional changes were also monitored for each material. All results were benchmarked to the Epon 828/1031/DDS system to provide useful perspectives of relative stabilities with respect to both volatile formation and dimensional stability.

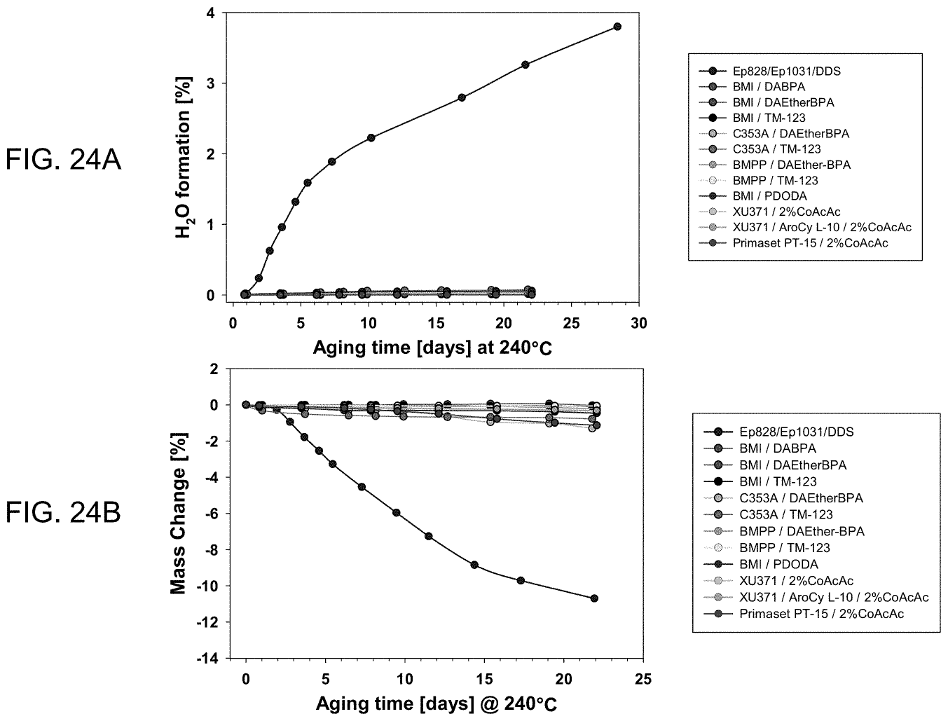

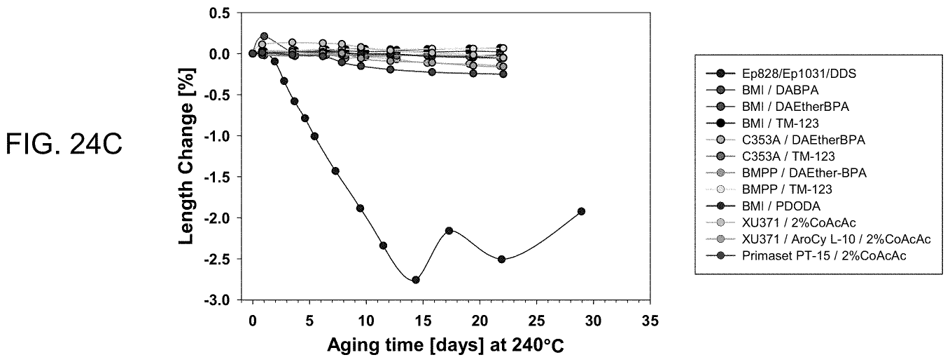

The results are shown in FIGS. 24A-24C which show water formation yield, mass change and length change for all materials. In brief, all eleven alternative encapsulation materials showed significantly less water produced when compared to the reference epoxy material. As described earlier, the presence of hydroxyl groups is strongly correlated to hydrolysis at elevated temperatures. However, these functional groups are also present in BMI materials cured with either DABPA or DAEtherBPA, yet these materials display markedly better stability. All exemplary encapsulation materials showed significantly less weight loss and shrinkage when compared to the reference epoxy material. These trends are strongly correlated to byproduct formation which is consistent with expectations from degradation reactions taking place.

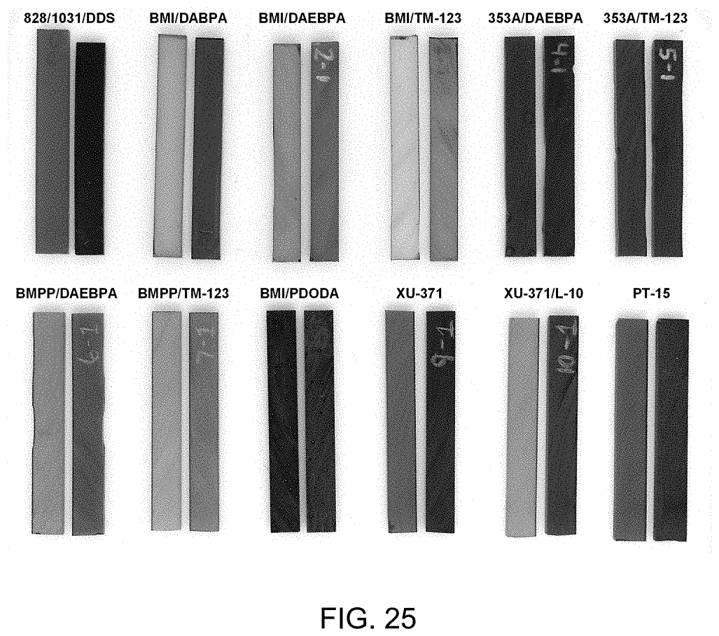

FIG. 25 shows photographs depicting color changes to bars of each resin when subjected to aging in dry nitrogen at 240° C. and 22 days. Table 5 shows each material system showing measured weight change and combustion products from aging at 240° C. for 22 days. Evidence for additional volatile degradation products were observed, such as acetic acid, methane, toluene, propene, and acetone, but calibration was not possible. Current limitations using IR based techniques mostly have to do with detection and resolution limits for each species. Nonetheless, it was possible to infer the presence of certain species which is noted in Table 5.

TABLE 5
Summary of other volatile components observed.

| | Weight | IR | IR | |
|---|---|---|---|---|
| | Change | Water | CO₂ | |
| | (20 days) | (20 days) | (20 days) | |
| Sample Name | 240° C. | 240° C. | 240° C. | Other Volatiles ID |
| 828/1031/DDS | −10.5% | 3.3% | 0.6% | Propene, Methane, Acetone, |
| | | | | Acetic Acid |
| BMI/DABPA | −0.1% | 0.06% | 0.14% | Toluene, Trace Methane |
| BMI/DAEtherBPA | −0.04% | 0.015% | 0.07% | Trace Methane, Trace Propene |
| BMI/TM-123 | −0.07% | 0.04% | 0.04% | Methane, Toluene, Trace Acetic |
| | | | | Acid, Trace Propene |
| C353A/ | −1.3% | 0.03% | 0.09% | Acetic Acid, Methane, Toluene, |
| DAEtherBPA | | | | Trace Propene |
| C353A/TM-123 | −0.8% | 0.075% | 0.07% | Acetic Acid, Toluene, Methane, |
| | | | | Trace Propene |
| BMPP/ | −0.22% | 0.05% | 0.05% | Methane, Propene, Toluene |
| DAEtherBPA | | | | |
| BMPP/TM-123 | −0.06% | 0.06% | 0.04% | Methane, Propene, Toluene |
| BMI/PDODA | −0.46% | 0.06% | 0.06% | Acetic Acid, Methane, Trace |
| | | | | Ammonia |
| XU371 pure plus | −0.34% | 0.008% | 0.22% | Trace Methane |
| 2% catalyst mix | | | | |
| XU371/AroCyL- | −0.31% | 0.007% | 0.19% | Trace Methane |
| 10 1:1 plus 2% | | | | |
| catalyst mix | | | | |
| Primaset PT-15 | −1.13% | 0.003% | 0.30% | Trace Methane |
| pure plus 2% | | | | |
| catalyst mix | | | | |

Despite the inability to calibrate all degradation byproducts, there are noticeable differences in composition of degradation products based on the chemistry of the system. For example, CE materials produced small amounts (<0.010%) of CO₂ with trace amounts of methane whereas BMI materials showed a wider range of products consisting of aromatics (toluene), carboxylic acids (acetic acid), ammonia, alkenes (propene), along with trace amounts of methane. The presence of imide groups could offer insights into the appearance of these compounds which can only originate from cleaving of the backbone followed by fragmentation. While the degradation mechanisms are undoubtedly complicated, these observations do offer useful perspectives of factors impacting chemistries.

### Basic Mechanical Properties of New Candidate Materials

In addition to withstanding prolonged operation at elevated temperatures, it is useful to compare mechanical strength of the BMI and CE thermoset materials to the Epon 828/1031/DDS system. Three preliminary mechanical tests were performed on seven BMI and CE systems demonstrating the most outstanding qualities from the earlier screening studies. Table 6 presents these materials under test and their cure conditions.

TABLE 6
Thermoset materials used in mechanical tests.

| Material # | Constituents | Ratio (wt.) | Cure Details |
|---|---|---|---|
| 1 | BMI/DABPA | 58:42 | 160° C. 20 hr, 240° C. |
| | | | 3 hr |
| 2 | BMI/TM123 | 49:51 | 165° C. 19 hr, 240° C. |
| | | | 3 hr |
| 3 | BMI/DABPA/DAEBPA | 58:32:10 | 165° C. 18 hr, 240° C. |
| | | | 3 hr |
| 4 | BMI/TM123/DAEBPA | N/A | 165° C. 15 hr, 240° C. |
| | | | 3 hr |
| 5 | BMPP/DABPA | 69:31 | 165° C. 18 hr, 240° C. |
| | | | 3 hr |
| 6 | BMPP/TM123/DAEBPA | 63:28:10 | 165° C. 16 hr, 240° C. |
| | | | 3 hr |
| 7 | XU-371/AroCyL-10 | 50:50 | 240° C. post cure |

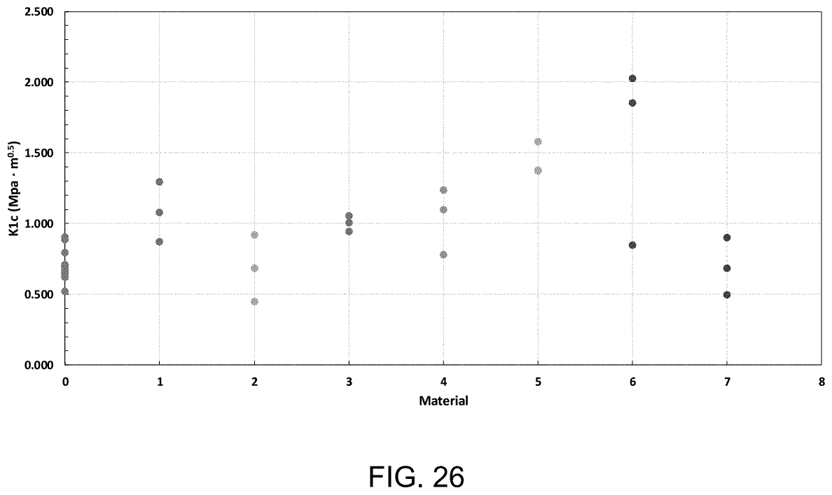

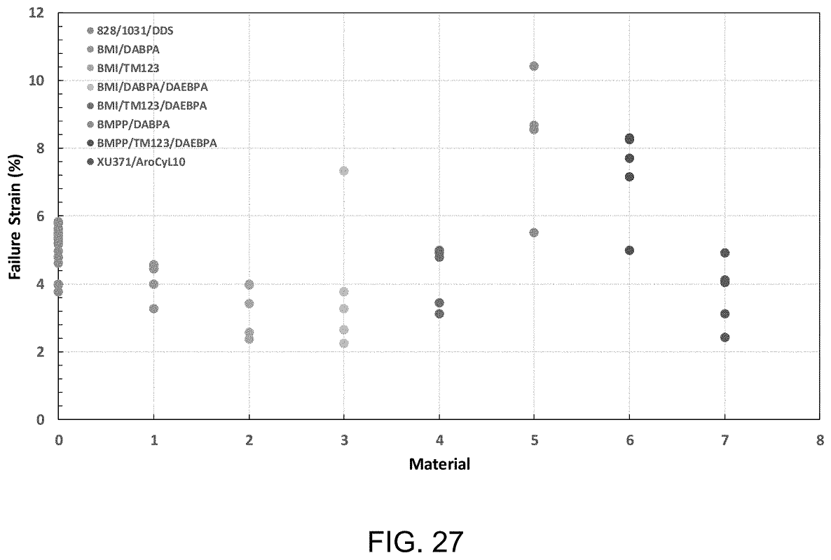

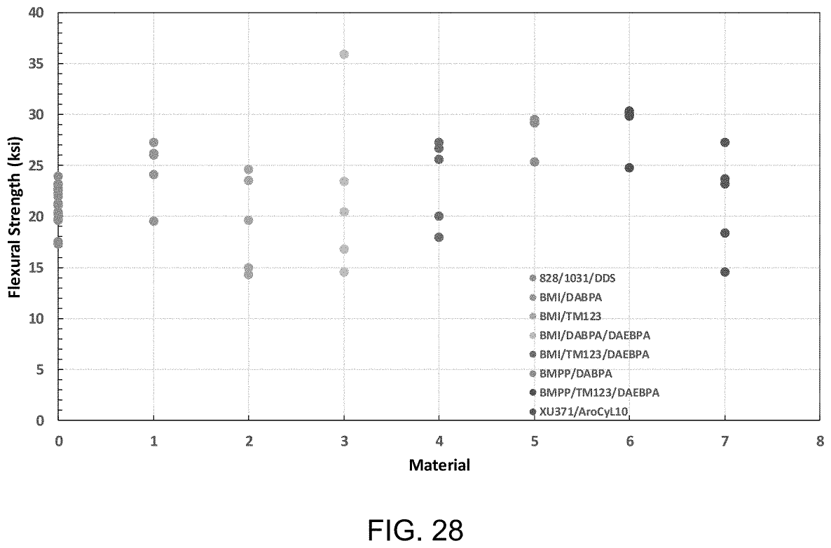

Among the mechanical tests performed were fracture toughness (K_{1c}), flexural strength (3 point bend), and compressive strength. Six BMI composites and one CE material were evaluated that displayed the best qualitative mechanical characteristics. Beginning with K_{1c}, all samples were cut into rectangular bars (0.5″×2.5″×0.25″) and notched before carrying out a 3-point bend test configuration. Fracture toughness results for the thermoset materials are shown in FIG. 26 which are comparable to, or higher than Epon 828/1031/DDS. Flexural strains and strengths were next examined and results appear in FIGS. 27 and 28.

Similar to fracture toughness, all thermoset materials exhibit comparable failure strains as Epon 828/1031/DDS. Several do have slightly lower average values indicating their more brittle nature. Flexural strengths are nearly all greater than the epoxy material where only materials 2 and 3 are slightly smaller. These trends demonstrate that no significant strength gains are realized as opposed to thermal stability. However, what remains to be seen is how much the mechanical properties become altered with thermal and oxidative aging.

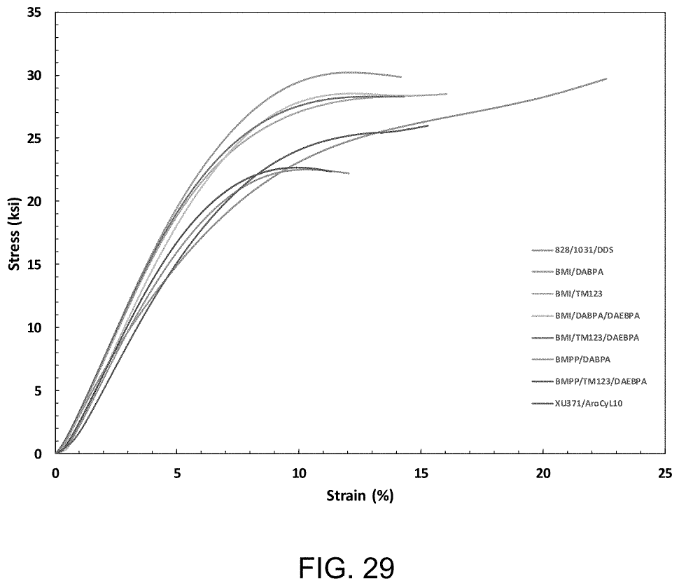

Next, the compressive modulus was recorded for each material in Table 6 and shown in FIG. 29. Interestingly, each thermoset material displays yielding behavior as opposed to Epon 828/1031/DDS which does not. Moreover, elastic moduli and yield stresses are like or greater than the epoxy material. Only the XU-371/AroCyL-10 response closely resembles the standard epoxy and yielding is less pronounced. This was also reflected in the elastic modulus where these materials appear identical in nature.

### Suitability of BMI and CE Thermosets for High Temperature Applications

In addition to resistance to pyrolytic degradation and outgassing, good mechanical properties and processability are also essential for most high temperature applications, such as binders for thermoelectric applications. See U.S. application Ser. No. 17/408,713, titled “Low-Outgassing Thermoelectric Module,” filed Aug. 23, 2021, which is incorporated herein by reference. Overall, BMI and CE systems displayed far better thermal stability characteristics than the epoxy system. Most notably, markedly lower mass loss and volatile evolution were observed in addition to low moisture uptake. While nearly all BMI systems have slightly larger T_{g} values than CE resins, issues with processability and mechanical properties were noted. For example, BMI/DABPA showed the best thermal stability performance of all alternative encapsulants but the cured form is extremely brittle, and workability of uncured resins was relatively poor (i.e., short shelf life). Therefore, tradeoffs between the ultimate attainable T_{g} and processing attributes may be necessary to arrive at a suitable material system.

To this end, CE materials offered a good compromise in high T_{g}, good thermal stability, low off-gassing and mass loss along with low viscosity and long working times. Moreover, combinations of CE monomers can be employed to fine-tune both cured and uncured state properties. Namely, novolac-type systems, such as XU-371, exhibit higher T_{g} and excellent stability whereas lower molecular weight CE monomers, such as AroCyL-10, tend to have low viscosities, such as, bisphenol variants. Combinations of these resins provide a facile avenue towards a composite material with a relatively high T_{g} and good thermal stability (e.g., resistance to pyrolytic degradation) together with low viscosity and long working times in the monomer state for processing. For example, 50:50 blends of XU-371 and AroCyL-10 produced a good candidate material whereby T_{g} and thermal stability were similar to the former but low viscosities could also be obtained as well as long processing times due to the higher temperature onset of vitrification.

Both BMI and CE resins also showed substantially lower volatile evolution than Epon 828/1031/DDS over comparable temperatures. In particular, high T_{g} CE systems only showed trace amounts of methane as opposed to several BMI resins that produced more off-gassing at elevated temperatures. This feature is particularly encouraging along with the negligible amount of water uptake and release although more detailed work is needed to fully understand the affinities of environmental contaminants for these materials.

The present invention has been described as thermoset polymers for high temperature applications. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method for synthesizing a bismaleimide thermoset, comprising:
providing a bismaleimide resin, and
curing the bismaleimide resin with a bismaleimide curative.

2. The method of claim 1, wherein the bismaleimide resin comprises methylenediphenylbismalemimide, or bisphenol A diphenyl ether bismaleimide.

3. The method of claim 1, wherein the bismaleimide curative comprises an allyl or propenyl curative.

4. The method of claim 3, wherein the allyl or propenyl curative comprises diallylbisphenol A, diallyl ether of bisphenol A, or bis(o-propenylphenoxy)benzophenone.

5. The method of claim 1, wherein the bismaleimide curative comprises an amine curative.

6. The method of claim 5, wherein the amine curative comprises 4,4′-Diam inodiphenyl sulfone; 1,3-Propanediol-bis(4-aminobenzoate); 3,3′-Diaminodiphenyl sulfone; 3,3′-Diaminobenzophenone; Bis[4-(4-aminophenoxy)phenyl]sulfone; 3,4-Oxydianiline; 4,4′-(1,3-Phenylenedioxy)dianiline; or 4,4′-Methylenedianiline.

7. The method of claim 1, wherein the bismaleimide resin comprises a blend of two or more bismaleimide resins, thereby synthesizing a bismaleimide composite.

8. A method of synthesizing a cyanate ester thermoset, comprising:
providing a cyanate ester resin, and
curing the cyanate ester resin with a phenolic hydroxy.

9. The method of claim 8, wherein the cyanate ester resin comprises a methylene-bridged trifunctional phenol, a methylene-bridged difunctional phenol, a bisphenol E cyanate ester, or a bisphenol M cyanate ester.

10. The method of claim 8, wherein the cyanate ester resin comprises a blend of two or more cyanate ester resins, thereby synthesizing a cyanate ester composite.

11. The method of claim 10, further comprising providing a catalyst to aid in the curing step.

12. The method of claim 11, wherein the catalyst comprises a tertiary amine, imidazole, urea, or a transition metal chelate/carboxylate catalyst.

13. The method of claim 12, wherein the transition metal chelate/carboxylate catalyst comprises cobalt(II) acetylacetonate.

14. A bismaleimide thermoset comprising a bismaleimide resin crosslinked with a bismaleimide curative.

15. The bismaleimide thermoset of claim 14, wherein the bismaleimide resin comprises methylenediphenylbismalemimide, or bisphenol A diphenyl ether bismaleimide.

16. The bismaleimide thermoset of claim 14, wherein the bismaleimide curative comprises an allyl or propenyl curative.

17. The bismaleimide thermoset of claim 16, wherein the allyl or propenyl curative comprises diallylbisphenol A, diallyl ether of bisphenol A, or bis(o-propenylphenoxy)benzophenone.

18. The bismaleimide thermoset of claim 14, wherein the bismaleimide curative comprises an amine curative.

19. The bismaleimide thermoset of claim 18, wherein the amine curative comprises 4,4′-Diaminodiphenyl sulfone; 1,3-Propanediol-bis(4-aminobenzoate); 3,3′-Diam inodiphenyl sulfone; 3,3′-Diaminobenzophenone; Bis[4-(4-aminophenoxy)phenyl]sulfone; 3,4-Oxydianiline; 4,4′-(1,3-Phenylenedioxy)dianiline; or 4,4′-Methylenedianiline.

20. The bismaleimide thermoset of claim 1, wherein the bismaleimide resin comprises a blend of two or more bismaleimide resins, thereby providing a bismaleimide composite.

21. A cyanate ester thermoset comprising a cyanate ester resin crosslinked with a phenolic hydroxy.

22. The cyanate ester thermoset of claim 21, wherein the cyanate ester resin comprises a methylene-bridged trifunctional phenol, a methylene-bridged difunctional phenol, a bisphenol E cyanate ester, or a bisphenol M cyanate ester.

23. The cyanate ester thermoset of claim 21, wherein the cyanate ester resin comprises a blend of two or more cyanate ester resins, thereby providing a cyanate ester composite.

24. The cyanate ester thermoset of claim 23, wherein the cyanate ester resin comprises a blend of a novolac-type cyanate ester and a bisphenol E cyanate ester.
